(19) United States
(12) Patent Application Publication
(10) Pub. No.: US 2026/0117040 A1
(43) Pub. Date: Apr. 30, 2026

(54) DEPOLYMERIZATION OF AMINATED ALL-CARBON POLYMER BACKBONES THROUGH AZA-COPE REARRANGEMENTS

(71) Applicant: THE UNIVERSITY OF NORTH CAROLINA AT CHAPEL HILL, Chapel Hill, NC (US)

(72) Inventors: Aleksandr V. ZHUKHOVITSKIY, Morrisville, NC (US); Maxim RATUSHNYY, Chapel Hill, NC (US)

(21) Appl. No.: 19/166,601

(22) PCT Filed: Mar. 14, 2024
(86) PCT No.: PCT/US24/19903

§ 371 Date: Sep. 18, 2025

Related U.S. Application Data
(60) Provisional application No. 63/454,452, filed on Mar. 24, 2023.

(51) Int. Cl. C08J 11/18

(52) U.S. Cl. CPC C08J 11/18; C08J 2300/106

(57) ABSTRACT

The present disclosure relates to rearranging an all-carbon backbone of a polymer to a nitrogen-containing backbone using an 2-aza-Cope rearrangement. Furthermore, these newly formed polymers with their nitrogen-containing backbones can be depolymerized into one or more non-polymeric nitrogen-containing molecules.

### GOVERNMENT SUPPORT

This invention was made with government support under Grant No. DE-SC0022898 awarded by the Department of Energy. The government has certain rights in the invention.

### TECHNICAL FIELD

The present disclosure relates to rearranging an all-carbon backbone of a polymer to a nitrogen-containing backbone using an 2-aza-Cope rearrangement. Furthermore, these newly formed polymers with their nitrogen-containing backbones can be depolymerized into one or more non-polymeric nitrogen-containing molecules.

### BACKGROUND

Plastic pollution has become a huge global problem with an estimated 9.5 million metric tons of macro- and micro-plastic (8:1.5) ending up in the ocean each and in the human food chain year. Among the largest contributors to plastic pollution are vinyl polymers and polyolefins.¹ Diene polymers alone represent the largest portion of commodity plastics globally with about 3 million metric tons (Mt) of polybutadiene (PB) produced in 2010 and rising. Although diene polymers can be found in macro- and micro-plastics, their dominant application is in rubber manufacturing. About 60% of all diene polymers is found in the production of synthetic rubber, including vulcanized cis-1,4-polybutadiene, polyisoprene, and styrenebutadiene rubbers (PBR, IR, and SBR, respectively) utilized in the manufacture of tires, which are ˜40% by mass in rubber.⁵⁻⁶ According to the US Tire Manufacturers Association, “macroscopic” recycling by forming ground rubber takes care of only 24% of the waste tires in the US; ˜14% of waste tires are still buried in landfills, and ˜37% is used to recover energy/fuel, which presents both environmental and economic externalities, especially considering the enormous scale of the waste.

The re-/up-cycling of these diene polymer materials remain an ongoing challenge due to the lack of available methods that are able to efficiently cleave carbon-carbon bonds that make up these polymer backbones.¹ These bonds typically require such high temperatures (≥350° C.) to be cleaved, that mixtures of products form, which further compounds the recycling problem.¹

Alternate strategies involve chemical/biochemical (i.e., enzymatic) treatments of rubber to re-/up-cycle or degrade it. One example of the chemical treatment is de-vulcanization, in which sulfur-sulfur and carbon-sulfur bonds have been broken with reagents like triphenylphosphine, sodium di-n-butyl phosphite, lithium aluminum hydride, iodomethane, and diphenyl disulfide.⁷⁻⁸ Toxicity, carcinogenicity, noxious smell, and high reactivity of these reagents presents a problem for scaling this process in the industry (FIG. 1A). Another chemical process takes advantage of the plentiful alkenes in the rubber materials—in particular, depolymerization through olefin metathesis with ethylene and oxidative degradation (FIG. 1A). Olefin metathesis has been explored in depth since the 1990s: most of the research has focused on the depolymerization of un-crosslinked polybutadiene and polyisoprene, and of the available catalysts, the 2nd generation Grubbs catalyst (G2) and its derivatives proved most effective.⁹ Most notably, the latter were even effective in the depolymerization of granulated tires, enabling the recovery of ˜50% by mass of soluble oligoisoprenes.² Despite the effectiveness of this approach, a key issue is the reliance on expensive ruthenium-based catalysts: for 1 kg of tire rubber, 5 g or ˜$1000-worth of G2 derivative would be required.²

Unfortunately, oxidative degradation using inorganic reagents (e.g., ozone, or periodate) or enzymatic oxidation (FIG. 1A) typically generates a broad distribution of oxidative products, some of which lead to further cross-linking of the rubber instead of degradation into soluble fragments.^{3,4, 10-13} Furthermore, enzymatic oxidation only affords partial molecular weight reduction in diene polymers and is compromised by the additives like plasticizers and antioxidants present in rubber waste.⁴ Lastly, diene polymer upcycling through chemical functionalization—e.g., through click reactions (FIG. 1B)—may present alternative methods, but thus far the leading methods struggle with stereo—and regio-control, functionalization yield, as well as the presence of undesirable cross-linking side reactions.^{4, 14-18}

Hence, alternative approaches are urgently needed, that are able to break up all-carbon-backbone polymers, such as the above-mentioned diene polymers, which can then be applied in the re-/up-cycling of diene polymers and rubber. These and other aspects are addressed by the disclosures herein.

### SUMMARY

In accordance with the purpose(s) of the currently disclosed subject matter, as embodied and broadly described herein, one aspect relates to a method of preparing a product polymer, the method comprising obtaining a starting polymer, wherein the backbone of the polymer comprises at least one sigmatropomer repeat unit; and inducing a 2-aza-Cope rearrangement of the sigmatropomer in the backbone of the starting polymer, thereby producing the product polymer.

In an embodiment, the sigmatropomer is a repeat unit of Formula I,

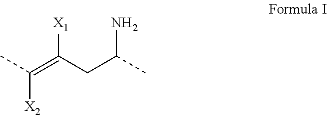

wherein X₁ and X₂ are independently selected from hydrogen, alkyl, aryl and heteroaryl. In some embodiments, X₁ and X₂ are hydrogen.

In an embodiment, the starting polymer is a compound of Formula IIa, IIb, or IIc:

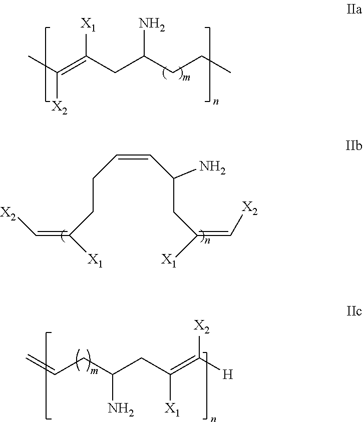

wherein X₁ and X₂ are independently selected from hydrogen, alkyl, aryl, and heteroaryl; m is an integer selected from 0-100; and n is an integer selected from 10-10,000. In some embodiments, X₁ and X₂ are hydrogen.

In an embodiment, the product polymer obtained from the described method comprises a nitrogen-containing backbone. Depolymerization of such a product polymer into smaller non-polymeric molecules afford at least one nitrogen-containing small molecule.

These and other aspects are disclosed in further detail below.

### BRIEF DESCRIPTION OF THE FIGURES

FIG. 1A shows (bio) chemical methods for the breakdown of vulcanized rubber.

FIG. 1B shows examples of diene polymer upcycling.

FIG. 2 shows 1H NMR comparison of starting material, MC4, and crude reaction mixture.

FIG. 3 shows with 1H NMR comparison of starting material, MP1·TFA, and crude reaction mixture.

FIG. 4 shows mass spectra of the starting material MP1.TFA (top spectra) and crude reaction mixture (bottom spectra) averaged over the shown spectral window (time=10-20 min).

FIG. 5 shows 1H NMR comparison of starting material polymer and crude reaction mixture.

FIG. 6 shows 1H NMR of the depolymerization of a non-polymeric starting material 1 to afford non-polymeric small molecules 2 and 3 as products.

FIG. 7 shows a 1H NMR study to identify the side product generated during the depolymerization of a non-polymeric starting material 5 to afford non-polymeric small molecules 6 and 7 as products.

FIG. 8 shows a 1H NMR time study to monitor the reaction progress of the aza-2-cope rearrangement of starting material polymer P1-TFA over a time period of 12 hours.

FIG. 9 shows GPC-MALS time studies to monitor the reaction progress of the aza-2-cope rearrangement of starting material polymer P1-TFA over a time period of 12 hours.

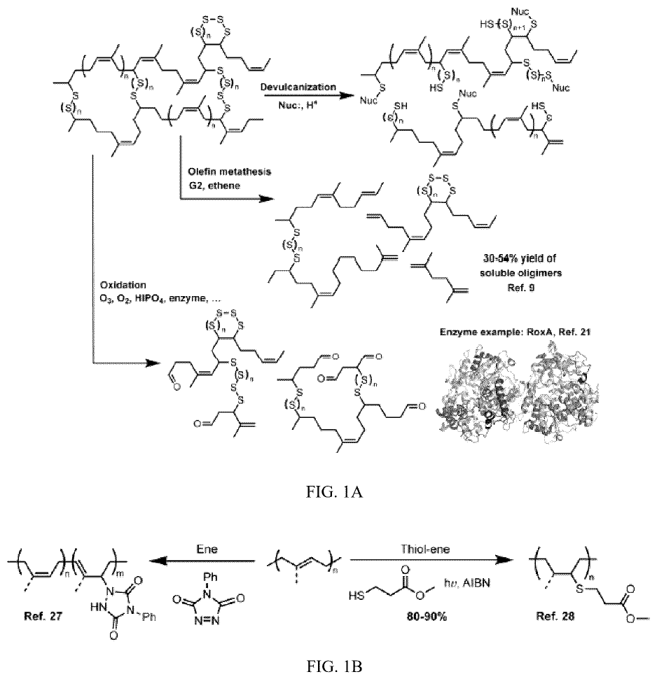

### DETAILED DESCRIPTION

The present invention can be understood more readily by reference to the following detailed description of the invention and the Examples included therein.

Before the present compounds, compositions, articles, systems, devices, and/or methods are disclosed and described, it is to be understood that they are not limited to specific synthetic methods unless otherwise specified, or to particular reagents unless otherwise specified, as such may, of course, vary. It is also to be understood that the terminology used herein is for the purpose of describing particular aspects only and is not intended to be limiting. Although any methods and materials similar or equivalent to those described herein can be used in the practice or testing of the present invention, example methods and materials are now described.

The current disclosure relates to polymers comprising a backbone capable of undergoing a 2-aza Cope rearrangement (ACR). Also described herein are methods for transforming the backbones of these polymers by subjecting them to 2-aza Cope rearrangements.

An Example is shown below, wherein a model polymer P can undergo a skeletal rearrangement via an aza-2-Cope rearrangement to render a polymer P′. In order for the backbone of the model polymer to undergo a 2-aza-Cope rearrangement, the backbone must comprise chemical moieties that can undergo a 2-aza-Cope rearrangement. These chemical moieties are referred to herein as “sigmatropomers.” As can be seen in Scheme 1, model polymers P contain an all-carbon backbone with homoallylic amine moieties as sigmatropomers S*, which undergo 2-aza-Cope rearrangements, thus providing the polymer P′. Of note is that polymer P′ now contains the nitrogen atoms originating from the sigmatropomers in the polymer backbone. Further modification of polymer P′ leads to depolymerization of P′ to afford nitrogen-containing non-polymeric small molecules as final products (see 2 in Scheme 1).

In addition to the above described polymers and oligomers, non-polymeric molecules can also undergo 2-aza-Cope rearrangement provided they contain at least on sigmatropomer moiety.

In some embodiments, the polymer of interest does not contain a sigmatropomer. In such instances, the sigmatropomer has to be installed prior to carrying out the 2-aza-Cope rearrangement. In some embodiments, the polymer of interest contains a polymer with an all-carbon backbone, such as diene polymers and diene rubber materials (i.e., vulcanized butadiene rubber and SBR). The all-carbon backbone of such polymers can be modified using known methods in the art. For example, the all-carbon backbone can be modified via an allylic C—H amination to install the sigmatropomer as disclosed herein. Methods for carrying out allylic C—H amination on an all-carbon backbone containing polymers are generally known in the art. For example, allylic amination of diene polymers catalyzed by NHC-selenium adducts can efficiently install the homoallylic amine sigmatropomer in the all-carbon backbone, thereby setting the stage for carrying out the 2-aza-Cope rearrangement (ACR) (see 1 in Scheme 1). Thus, C—H amination followed by ACR of the all-carbon backbone is an efficient reaction sequence to produce polymer products with nitrogen atoms in the polymer backbone, which upon depolymerization renders various valuable-added nitrogen-containing non-polymeric small molecules (see 3 in Scheme 1).

Of note is that, the position of the allylic amine is important and needs to be installed on the diene polymer so as to also be homoallylic with respect to the other neighboring alkene—this fact will enable the target skeletal rearrangement.

While aspects of the present invention can be described and claimed in a particular statutory class, such as the system statutory class, this is for convenience only and one of skill in the art will understand that each aspect of the present invention can be described and claimed in any statutory class. Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is in no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

### A. DEFINITIONS

Listed below are definitions of various terms used to describe this invention. These definitions apply to the terms as they are used throughout this specification, unless otherwise limited in specific instances, either individually or as part of a larger group.

As used in the specification and the appended claims, the singular forms “a,” “an” and “the” include plural referents unless the context clearly dictates otherwise. Thus, for example, reference to “an alkyl group” or “a polymer” includes mixtures of two or more such alkyl groups or polymers.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units is also disclosed. For example, if 10 and 15 are disclosed, then 11, 12, 13, and 14 are also disclosed.

A weight percent (wt %) of a component, unless specifically stated to the contrary, is based on the total weight of the vehicle or composition in which the component is included.

Throughout this specification and the claims, the words “comprise,” “comprises,” and “comprising” are used in a nonexclusive sense, except where the context requires otherwise. It is understood that embodiments described herein include “consisting of” and/or “consisting essentially of” embodiments.

As used herein, the “contacting” refers to reagents in close proximity so that a reaction may occur.

As used herein, “ambient temperature” or “room temperature” refers to a temperature in the range of about 20° C. to about 25° C.

As used herein, the term “alkyl” refers to a straight or branched chain hydrocarbon containing from 1 to 10 carbon atoms. Representative examples of alkyl include, but are not limited to, methyl, ethyl, n-propyl, isopropyl, n-butyl, sec-butyl, isobutyl, tert-butyl, n-pentyl, isopentyl, neopentyl, n-hexyl, 3-methylhexyl, 2,2-dimethylpentyl, 2,3-dimethylpentyl, n-heptyl, n-octyl, n-nonyl, n-decyl, and the like. These groups may be substituted with groups selected from halo (e.g., haloalkyl), alkyl, haloalkyl, alkenyl, alkynyl, cycloalkyl, cycloalkylalkyl, aryl, arylalkyl, heterocyclo, heterocycloalkyl, hydroxyl, alkoxy (thereby creating a polyalkoxy such as polyethylene glycol), alkenyloxy, alkynyloxy, haloalkoxy, cycloalkoxy, cycloalkylalkyloxy, aryloxy, arylalkyloxy, heterocyclooxy, heterocyclolalkyloxy, mercapto, carboxy, alkylamino, alkenylamino, alkynylamino, haloalkylamino, cycloalkylamino, cycloalkylalkylamino, arylamino, arylalkylamino, heterocycloamino, heterocycloalkylamino, disubstituted-amino, ester, amide, nitro, or cyano.

The term “cycloalkyl” refers to a hydrocarbon 3-8 membered monocyclic or 7-14 membered bicyclic ring system having at least one saturated ring or having at least one non-aromatic ring, wherein the non-aromatic ring may have some degree of unsaturation. Cycloalkyl groups may be optionally substituted with one or more substituents. In one embodiment, 0, 1, 2, 3, or 4 atoms of each ring of a cycloalkyl group may be substituted by a substituent. Representative examples of cycloalkyl group include cyclopropyl, cyclopentyl, cyclohexyl, cyclobutyl, cycloheptyl, cyclopentenyl, cyclopentadienyl, cyclohexenyl, cyclohexadienyl, and the like.

As used herein, the term “alkenyl” refers to unsaturated aliphatic groups analogous in length and possible substitution to the alkyls described above, but that contain at least one double bond. For example, the term “alkenyl” includes straight-chain alkenyl groups (e.g., ethylenyl, propenyl, butenyl, pentenyl, hexenyl, heptenyl, octenyl, nonenyl or decenyl), branched-chain alkenyl groups and cycloalkenyl (alicyclic) groups (cyclopropenyl, cyclopentenyl, cyclohexenyl, cycloheptenyl or cyclooctenyl) groups. The term alkenyl further includes alkenyl groups that include oxygen, nitrogen, sulfur or phosphorous atoms replacing one or more carbons of the hydrocarbon backbone. In certain embodiments, a straight chain or branched chain alkenyl group with 10 or fewer carbon atoms in its backbone (e.g., C2-C10 for straight chain, C3-C10 for branched chain) is used. Likewise, cycloalkenyl groups may have from 3-8 carbon atoms in their ring structure, and more preferably have 5 or 6 carbons in the ring structure. The term C2-C10 includes alkenyl groups containing 2 to 10 carbon atoms.

As used herein, the term “heteroaryl” or “heteroaromatic” refers to a monovalent aromatic radical of 5- or 6-membered rings, and includes fused ring systems (at least one of which is aromatic) of 5-20 atoms, containing one or more heteroatoms independently selected from nitrogen, oxygen, and sulfur. Examples of heteroaryl groups are pyridinyl (including, for example, 2-hydroxypyridinyl), imidazolyl, imidazopyridinyl, pyrimidinyl (including, for example, 4-hydroxypyrimidinyl), pyrazolyl, triazolyl (including, for example, 3-amino-1,2-4-triazole or 3-mercapto-1,2,4-triazole), pyrazinyl (including, for example, aminopyrazine), tetrazolyl, furyl, thienyl, isoxazolyl, thiazolyl, oxadiazolyl, oxazolyl, isothiazolyl, pyrrolyl, quinolinyl, isoquinolinyl, tetrahydroisoquinolinyl, indolyl, benzimidazolyl, benzofuranyl, cinnolinyl, indazolyl, indolizinyl, phthalazinyl, pyridazinyl, triazinyl, isoindolyl, pteridinyl, purinyl, oxadiazolyl, triazolyl, thiadiazolyl, thiadiazolyl, furazanyl, benzofurazanyl, benzothiophenyl, benzothiazolyl, benzoxazolyl, quinazolinyl, quinoxalinyl, naphthyridinyl, and furopyridinyl. The heteroaryl groups are thus, in some embodiments, monocyclic or bicyclic. Heteroaryl groups are optionally substituted independently with one or more substituents described herein.

As used herein, the term “aryl” refers to a hydrocarbon monocyclic, bicyclic or tricyclic aromatic ring system. Aryl groups may be optionally substituted with one or more substituents. In one embodiment, 0, 1, 2, 3, 4, 5 or 6 atoms of each ring of an aryl group may be substituted by a substituent. Examples of aryl groups include phenyl, naphthyl, anthracenyl, fluorenyl, indenyl, azulenyl, and the like.

As used herein, the term “substituted” refers to a moiety (such as an alkyl group), wherein the moiety is bonded to one or more additional organic radicals. In some embodiments, the substituted moiety comprises 1, 2, 3, 4, or 5 additional substituent groups or radicals. Suitable organic substituent radicals include, but are not limited to, hydroxyl, amino, mono-substituted amino, di-substituted amino, mercapto, alkylthiol, alkoxy, substituted alkoxy or haloalkoxy radicals, wherein the terms are defined herein. Unless otherwise indicated herein, the organic substituents can comprise from 1 to 4 or from 5 to 8 carbon atoms. When a substituted moiety is bonded thereon with more than one substituent radical, then the substituent radicals may be the same or different.

As used herein, the term “alkoxy”, used alone or as part of another group, means the radical —OR, where R is an alkyl group as defined herein.

As used herein, the terms “halo,” “halogen,” and “halide” refer to any suitable halogen, including —F, —Cl, —Br, and —I.

As used herein, the term “mercapto” refers to an —SH group.

As used herein, the term “cyano” refers to a —CN group.

As used herein, the term “carboxylic acid” refers to a —C(O) OH group.

As used herein, the term “hydroxyl” refers to an —OH group.

As used herein, the term “nitro” refers to an —NO₂ group.

As used herein, the term “sulfonyl” refers to the SO₂⁻ group. The “sulfonyl” may refer to a sulfonyl group, which is, for example, an alkylsulfonyloxy group such as a methylsulfonyloxy or ethylsulfonyloxy group and an aromatic sulfonyloxy group such as a benzenesulfonyloxy or tosyloxy group.

As used herein, the terms “ether” and “alkylether” are represented by the formula Rₐ—O—R_{b}, where Rₐ and R_{b} can be, independently, an alkyl, cycloalkyl, alkenyl, cycloalkenyl, alkynyl, cycloalkynyl, aryl, or heteroaryl group as described herein. The term “polyether” as used herein is represented by the formula —(Rₐ—O—R_{b})ₓ—, where Rₐ and R_{b} can be, independently, an alkyl, cycloalkyl, alkenyl, cycloalkenyl, alkynyl, cycloalkynyl, aryl, or heteroaryl group described herein and “x” is an integer from 1 to 500. Examples of polyether groups include polyethylene oxide, polypropylene oxide, and polybutylene oxide.

As used herein, the term “acyl”, used alone or as part of another group, refers to a —C(O)R radical, where R is any suitable substituent such as aryl, alkyl, alkenyl, alkynyl, cycloalkyl or other suitable substituent as described herein.

As used herein, the terms “alkylthio” and “thiyl,” used alone or as part of another group, refers to an alkyl group, as defined herein, appended to the parent molecular moiety through a thio moiety, as defined herein. Representative examples of alkylthio include, but are not limited, methylthio, ethylthio, tert-butylthio, hexylthio, and the like.

As used herein, the term “amino” means the radical —NH₂.

As used herein, the term “alkylamino” or “mono-substituted amino”, used alone or as part of another group, means the radical —NHR, where R is an alkyl group.

As used herein, the term “disubstituted amino”, used alone or as part of another group, means the radical —NRₐR_{b}, where Rₐ and R_{b} are independently selected from the groups alkyl, haloalkyl, alkenyl, alkynyl, cycloalkyl, cycloalkylalkyl, aryl, arylalkyl, heterocyclo, and heterocycloalkyl.

As used herein, the term “ester”, used alone or as part of another group, refers to a —C(O)OR radical, where R is any suitable substituent such as alkyl, cycloalkyl, alkenyl, alkynyl or aryl.

As used herein, the term “amide”, used alone or as part of another group, refers to a —C(O)NRₐR_{b} radical, where Rₐ and R_{b} are any suitable substituent such as alkyl, cycloalkyl, alkenyl, alkynyl or aryl.

As used herein, the term “unsubstituted” refers to a moiety (such as an alkyl group) that is not bonded to one or more additional organic or inorganic substituent radical as described above, meaning that such a moiety is only substituted with hydrogens.

### B. 2-AZA-COPE SIGMATROPIC REARRANGEMENT

Sigmatropic rearrangements are known in the art as a class of chemical reactions. Sigmatropic rearrangements are a class of pericyclic reactions²¹ that, phenomenologically, transpose molecular payloads across a system of conjugated orbitals.²²

More than a century since the first report of sigmatropic rearrangements in 1912,²³ only eleven studies have explored them in the context of polymers.²⁴⁻³⁵ Five of these studies are theoretical: Roald Hoffmann and coworkers concocted intriguing hypothetical classes of polymers they called “sigmatropic shiftamers,” because they predicted sigmatropic shifts—either Cope rearrangements or [1,n]-hydride shifts—would render the polymer fluxional along its entire backbone.²⁴⁻²⁹ The other six studies were experimental and utilized (orthoester-) Claisen rearrangements for peripheral modification of polyaramids and polyimides³¹⁻³⁴ or the surface of graphene oxide,³⁰ or diaza-Cope rearrangement to mediate step-growth polymerization of diamines and dialdehydes.³⁵

In order to perform a sigmatropic rearrangement on the backbone of polymer P comprising a sigmatropomer, the sigmatropomer comprising polymer P must first be obtained. The sigmatropomer-containing polymers may be prepared by methods disclosed herein.

As used herein, the terms “sigmatropic” and “sigmatropic rearrangement” refer to migration in an intramolecular process of a sigma (σ) bond, adjacent to one or more pi (π) systems, to a new position in a molecule, with the pi systems becoming reorganized in the process. A particular sigmatropic rearrangement for this disclosure is the 2-aza-Cope sigmatropic rearrangement, also referred to simply as the 2-aza-Cope rearrangement. The 2-aza-Cope rearrangement is a concerted cyclic transposition of σ and π bonds of a 1-ene-5-iminium fragment, which typically proceeds readily and reversibly under mild conditions enabling complex skeletal editing.¹⁹⁻²⁰ It is an example of a heteroatom version of the Cope rearrangement, which is a [3,3]-sigmatropic rearrangement that shifts single and double bonds between two allylic components as is shown below:

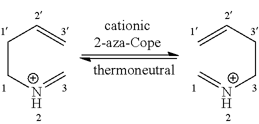

The presence of the ionic nitrogen heteroatom in the 2-aza-Cope rearrangement allows for a more facile rearrangement in comparison to the Cope rearrangement, which has no product bias as the bonds broken and formed are equivalent in either direction of the reaction. Hence, the 2-aza-Cope rearrangement is often paired with a thermodynamic sink to bias a rearrangement product. The positive charge on the nitrogen atom post rearrangement (often referred to as the iminium ion moiety) is often quenched with a nucleophile such as water or an alcohol to obtain a primary amine.

Sigmatropic rearrangements, including 2-aza-Cope rearrangements are generally initiated by methods known in the art, which include, but are not limited to, heating the sigmatropomer-containing polymer or non-polymeric small molecule, and/or contacting the sigmatropomer-containing polymer or non-polymeric small molecule with acid or base.

### C. SIGMATROPOMERS

The polymers (including oligomers) described herein have a backbone with at least one repeat unit which is a sigmatropomer. As used herein, the term “sigmatropomer” refers to a repeat unit in the backbone of a polymer which may on its own or in the presence of a suitable reactant or reagent undergo an 2-aza-Cope rearrangement. In some embodiments, the sigmatropomer is a repeat unit of Formula I.

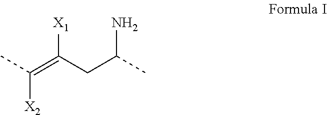

wherein X₁ and X₂ are independently selected from hydrogen, alkyl, aryl and heteroaryl.

In some embodiments, X₁ and X₂ are hydrogen.

In the sigmatropomer of Formula I, the dashed lines represent a chemical bond that is covalently attached to another repeat unit or an alternate section of the polymer.

In addition to polymers, non-polymeric molecules can also contain a sigmatropomer of Formula I. In such embodiments, the sigmatropomer is covalently attached to an atom (e.g., a carbon atom) of the non-polymeric molecule.

### D. SIGMATROPOMER—CONTAINING POLYMERS AND NON-POLYMERIC MOLECULES

The polymers disclosed herein having a backbone with at least one sigmatropomer as disclosed herein and the non-polymeric molecules containing a sigmatropomer disclosed herein are selected from a compound of Formula IIa, IIb, or IIc:

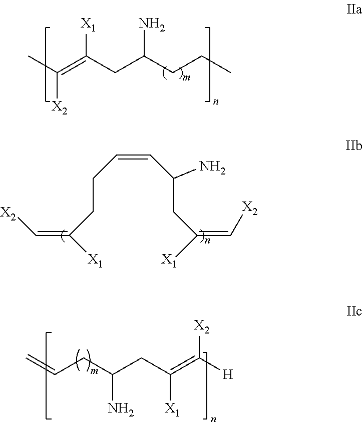

wherein X₁ and X₂ are independently selected from hydrogen, alkyl, aryl, and heteroaryl.

In some embodiments, n is an integer selected from 1-10,000, for example, from 1-5,000, 1-1,000, 1-500, 1-250, 1-100, or 1-50. In some embodiments, n is an integer selected from 1-40, 1-35, 1-30, 1-25, 5-25, 10-20, 10-15, 15-20, or 12-16. In some embodiments, n is an integer selected from 10-10,000, 100-10,000, 1,000-10,000, 2,000-10,000, 2,000-8,000, 3,000-8,000, 4,000-6,000 or 5,000-6,000. In some embodiments, n is in integer selected from 50-100, 75-100, 75-85, or 10-85. In some embodiments, n is 12. In some embodiments, n is 82.

In some embodiments, X₁ and X₂ are hydrogen.

In some embodiments, m is an integer selected from 0-100, 1-100, 1-50, 1-20, 1-15, 1-10, 1-8, 1-5, or 1-3. In some embodiments, m is an integer selected from 1, 2, 3, 4, 5, 6, 7, 8, 9, and 10.

In some embodiments, m is 4 and n is 1. In some embodiments, m is 4 and nis 12.

In some embodiments, the average molecular weight of the polymer disclosed herein is in the range from about 500 g/mol to about 200,000, from about 1,000 g/mol to about 50,000 g/mol, from about 1,500 g/mol to about 25,000 g/mol, from about 2,000 g/mol to about 15,000 g/mol, or from about 2,500 g/mol to about 5,000 g/mol. In some embodiments, the average molecular weight of the polymer PM is less than about 100,000 g/mol, less than about 50,000 g/mol, less than about 25,000 g/mol, less than about 10,000 g/mol, or less than about 5,000 g/mol. In some embodiments, the average molecular weight of the polymer PM is about 2,500 g/mol, about 5,000 g/mol, about 10,000 g/mol, about 25,000 g/mol, about 50,000 g/mol, or about 100,000 g/mol.

In some embodiments, the molecular weight of the non-polymeric molecules disclosed herein is in the range from about 80 g/mol to about 500 g/mol, from about 100 g/mol to about 450 g/mole, from about 150 g/mole to about 400 g/mole, from about 200 g/mole to about 350 g/mole, or from about 250 g/mole to about 350 g/mole.

### E. PRODUCT POLYMERS VIA BACKBONE REARRANGEMENT AND DEPOLYMERIZATION PRODUCTS

As already mentioned above, methods for modifying polymers with an all-carbon backbone containing at least one sigmatropomer to render polymers with a nitrogen-containing backbone are disclosed herein. These nitrogen-containing backbone polymers can then be further modified to afford non-polymeric nitrogen-containing small molecules via depolymerization of such nitrogen-containing backbone polymers.

Thus, the first aspect of the disclosure relates to a method for preparing a product polymer having a nitrogen-containing backbone, the method comprising:
(a) obtaining a starting polymer, wherein the backbone of the starting polymer comprises at least one sigmatropomer repeat unit; and
(b) inducing a 2-azo-Cope rearrangement of the sigmatropomer in the backbone of the starting polymer, thereby producing the product polymer.

The starting polymer is selected from a compound of Formula IIa, or IIb. In some embodiments, these starting polymers contain at least one sigmatropomer repeat unit, wherein the sigmatropomer repeat unit is a repeat unit of Formula I as disclosed herein.

The induction of the 2-azo-Cope rearrangement, in some embodiments, occurs at a temperature not much above room temperature (25° C.). In some embodiments, the 2-azo-Cope rearrangement is induced/carried out at a temperature ranging from about 30° C. to about 150° C., from about 30° C. to about 125° C., from about 30° C. to about 100° C., from about 30° C. to about 80° C., from about 30° C. to about 70° C., from about 35° C. to about 65° C., from about 40° C. to about 60° C., or from about 45° C. to about 55° C. In some embodiments, the temperature is about 50° C.

In some embodiments, induction of the 2-azo-Cope rearrangement occurs in the presence of an acid. The pKa of the acid can vary. In some embodiments, the pKa of the acid ranges from about 1 to about 5, from about 1 to about 4, from about 1 to about 3, or from about 1 to about 2. In some embodiments, the acid is a Brønsted acid. Exemplary Brønsted acids include, but are not limited to, hydrochloric acid, sulfuric acid, nitric acid, acetic acid, (+)-camphorsulfonic acid (CSA), diphenylphosphate (DPP), p-toluenesulfonic acid (PTSA).

In some embodiments, induction of the 2-azo-Cope rearrangement occurs in the absence of an acid.

The reaction time for inducing/carrying out the 2-azo-Cope rearrangement can vary. In some embodiments, the reaction time ranges from about 1 hours to about 24 hours, from about 5 hours to about 24 hours, from about 10 hours to about 24 hours, from about 15 hours to about 24 hours, from about 18 hours to about 22. In some embodiments, the reaction time is about 20 hours.

In some embodiments, the induction of the 2-azo-Cope rearrangement occurs in the presence of an aldehyde R₂—C(═O) H, wherein R₂ is selected from cycloalkyl, alkyl, aryl, and heteroaryl. In some embodiments, R₂ is selected from (C₃-C₆) cycloalkyl, (C₄-C₁₀) alkyl, phenyl, and pyridinyl. In some embodiments, the aldehyde that does not contain an enolizable carbon. Exemplary aldehydes include, but are not limited to, formaldehyde (formalin), benzaldehyde, 4-pyridinecarboxaldehyde, cyclohexanecarboxaldehyde, 4-nitrobenzaldehyde, and biphenyl-4-carboxaldehyde.

In some embodiments, the starting polymer already contains the sigmatropomer. For example, the starting polymer is a commercially available polymer. In some embodiments, the starting polymer cannot be obtained from commercial sources and needs to be prepared synthetically. For example, the starting polymer can be prepared from polymers lacking a sigmatropomer, e.g., a polymer containing an all-carbon backbone such as a diene polymer. In such instances, the sigmatropomer can be installed in these polymers using known methods in the art.

The product polymers obtained by the method disclosed herein contain at least one nitrogen atom in the backbone. In some embodiments, the at least one nitrogen atom in the backbone of the product polymer carries a positive charge. In some embodiments, the at least one nitrogen atom in the backbone is part of an iminium cation moiety.

In some embodiments, the product polymer can be further modified. For example, in some embodiments, the product polymer can be depolymerized into one or more non-polymeric small molecules. Thus, the above method further comprises a depolymerizing step wherein the polymer product is contacted with a depolymerizing agent. The type of depolymerizing agent can vary. For example, in some embodiments, the depolymerizing agent is water, an alcohol solvent, or a combination thereof, but should not be limited thereto. In some embodiments, the alcohol solvent is selected from methanol, ethanol, isopropanol, and n-butanol. In some embodiments, the depolymerizing agent is a combination of water and methanol.

In some embodiments, at least one of these non-polymeric small molecules is a nitrogen-containing molecule.

In some embodiments, the depolymerization step is carried out at a temperature above room (25° C.). In some embodiments, the depolymerization step carried out at a temperature ranging from about 30° C. to about 150° C., from about 30° C. to about 125° C., from about 30° C. to about 100° C., from about 30° C. to about 80° C., from about 30° C. to about 70° C., from about 35° C. to about 65° C., from about 40° C. to about 60° C., or from about 45° C. to about 55° C. In some embodiments, the temperature is about 50° C.

The reaction time for the depolymerization step can vary. In some embodiments, the reaction time ranges from about 1 hours to about 24 hours, from about 5 hours to about 24 hours, from about 10 hours to about 24 hours, from about 15 hours to about 24 hours, from about 18 hours to about 22. In some embodiments, the reaction time is about 20 hours.

Scheme 2 below shows an exemplary mechanism of the backbone rearrangement of a starting polymer of formula IIa as disclosed in the presence of an aldehyde (RCHO) to obtain a product polymer PP, which then can depolymerize via two different pathways in the presence of water or an alcohol (ROH) to afford non-polymeric nitrogen-containing small molecules Prod-1 and Prod-2. According to Scheme 2, an 2-aza-Cope rearrangement (ACR) of the starting polymer, such as a compound of formula IIa, containing an all-carbon backbone with a sigmatropomer as disclosed herein would result in the transposition of a labile iminium fragment into the backbone of product polymer PP. This first rearrangement enables depolymerization, but not the ability to regenerate the aldehyde to render its action catalytic; to achieve the latter, another ACR needs to take place. Notably, two pathways for this catalysis are possible, shown in Scheme 2: the first one proceeds via ACR of acyclic iminium species with a pendant vinyl group derived from Int-1 and requires a boat-like transition state (TS) to ultimately form Prod-1; meanwhile, in the second pathway Int-1 first isomerizes to Int-2, which then proceeds to form a macrocyclic iminium that undergoes ACR with a chair-like TS, and ultimately affords Prod-2. The former is expected to require higher temperatures because of the higher energy boat-like TS, while the latter is expected to proceed under mild conditions. It would be expected that depolymerization will be thermodynamically favored, driven largely by the increase in translational entropy¹²¹; however, subsequent aldehyde regeneration may need to be driven by the continuous removal (e.g., via distillation) of aminocycloalkenes with moderate ring strain. With a judicious choice of a nonvolatile aldehyde (e.g., 4-phenylbenzaldehyde), the depolymerization of all-carbon polymer backbones into non-polymeric small molecule amines can be rendered catalytic.

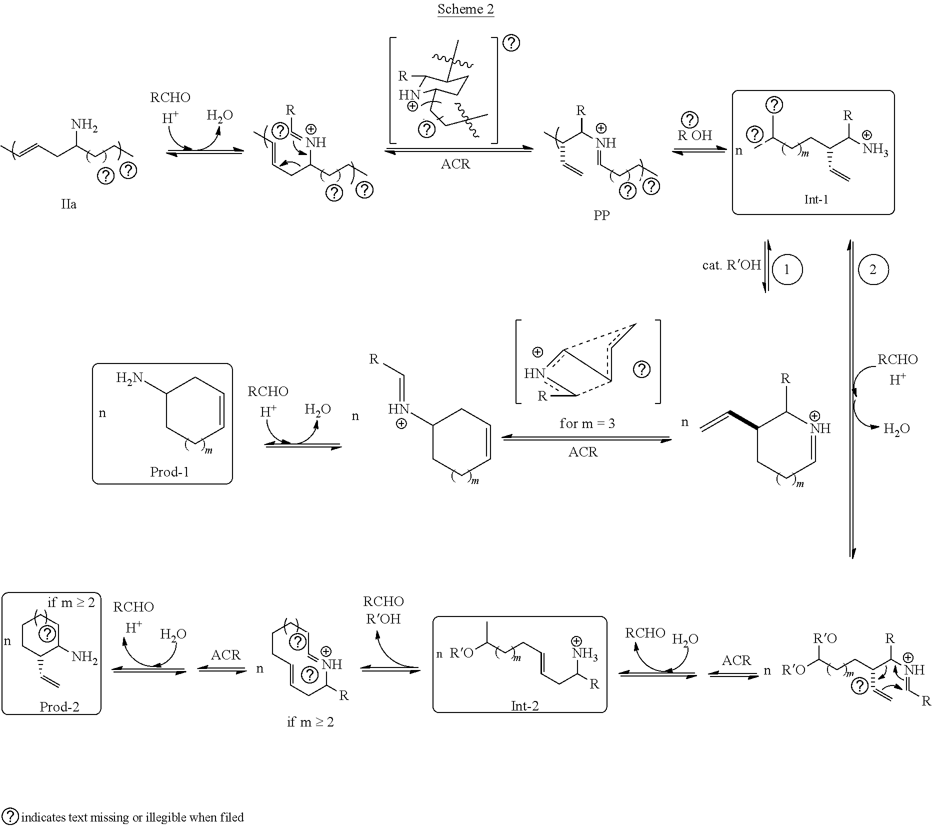

Thus, based on the reaction mechanisms presented in Scheme 2, of the above-described method using a starting polymer of a compound of Formula IIa, wherein X₁ and X₂ are hydrogen, would render a product polymer of a compound of Formula PPa:

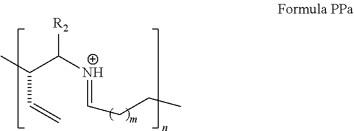

wherein R₂, m and n are the same as described above

In some embodiments, above-described method uses a non-polymeric molecule as a starting material. Thus, another aspect of the current disclosure is a method for preparing a non-polymeric product having a nitrogen in the carbon skeleton of the non-polymeric starting material, the method comprising:
(a) obtaining a non-polymeric starting material, wherein the carbon skeleton of the non-polymeric starting material comprises at least one sigmatropomer repeat unit; and
(b) inducing a 2-azo-Cope rearrangement of the sigmatropomer in the carbon skeleton of the non-polymeric starting material, thereby producing the product material.

As already mentioned above, the non-polymeric starting material is a molecule that contains at least one sigmatropomer as disclosed herein, i.e., a sigmatropomer of Formula I. In some embodiments, the starting material is a compound of Formula IIc, wherein X₁ and X₂ are hydrogen.

In some embodiments, the product material obtained by the method above is a compound of formula PPc

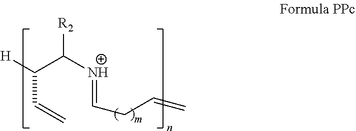

wherein R₂, m and n are the same as described above.

In some embodiments, the product polymer or product material selected from a compound of Formulae PPa and PPc can be further modified. For example, in some embodiments, the compounds of Formulae PPa and PPc are depolymerized by contacting the compound with a depolymerizing as described above to afford one or more nitrogen-containing non-polymeric small molecules. At least one of the nitrogen-containing non-polymeric small molecules comprises a nitrogen-containing moiety of Formula III:

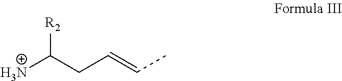

wherein the dashed lines represent a chemical bond that is covalently attached to any of the carbon atoms present in the nitrogen-containing compound.

Another aspect of the disclosure relates to a particular embodiment, wherein the diene polymers as shown in Scheme 4 under an 2-aza-Cope rearrangement to afford a polymer product with a nitrogen-containing backbone, which can be further modified via depolymerization to produce non-polymeric nitrogen-containing aromatic small molecules.

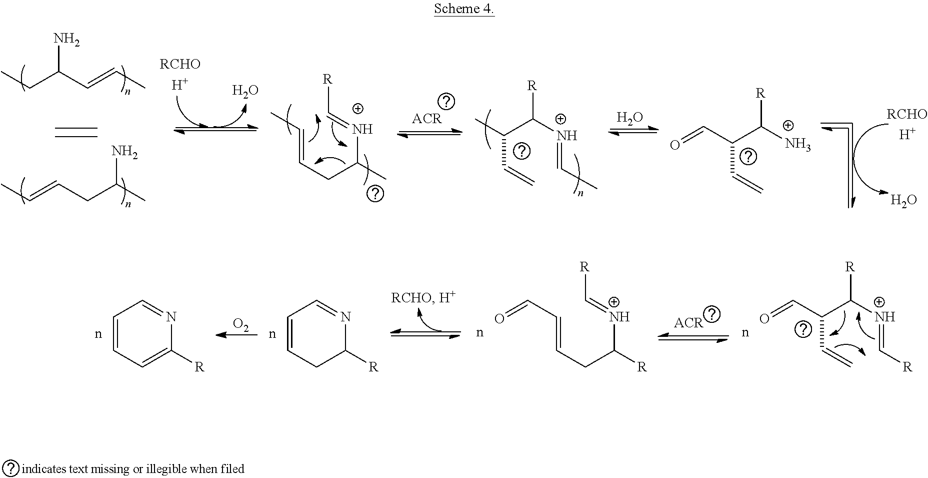

The polyamine of E-/Z-1,4-polybutadiene is subjected to aza-2-Cope rearrangement conditions as described above to produce the polymer product, which then proceeds through a similar mechanism as described above with respect to starting polymer IIa in Scheme 2 with an important caveat: dihydropyridine intermediates are expected to form, and in the presence of oxygen, these oxidatively unstable intermediates are expected to undergo oxidative aromatization to form 3-substituted pyridines³⁵. This product is expected to accumulate because of its aromatic stabilization.

These substituted pyridines represent valuable heterocycles, which are very useful as organic bases and building blocks in polymer and medicinal chemistry-will be major products of depolymerization due to their aromatic stabilization.

Another aspect of the disclosure relates to a particular embodiment, wherein the disclosed ACR reaction conditions are applied to aminated rubber species S38, shown in Scheme 5 below. It was found that after just 3 hours of reaction complete dissolution of the crosslinked material and formation of polymeric products were observed, which were detected by 1H NMR and GPC (after global Boc-protection). Monitoring by GPC showed at this point, that the polymer molecular weight had degraded to Mv of 39.5 kg/mol (the starting polymer used in rubber synthesis has Mw: 300. kg/mol). Furthermore, after 48 hours this weight had further degraded to an Mv of 13.9 kg/mol (see Table 1)

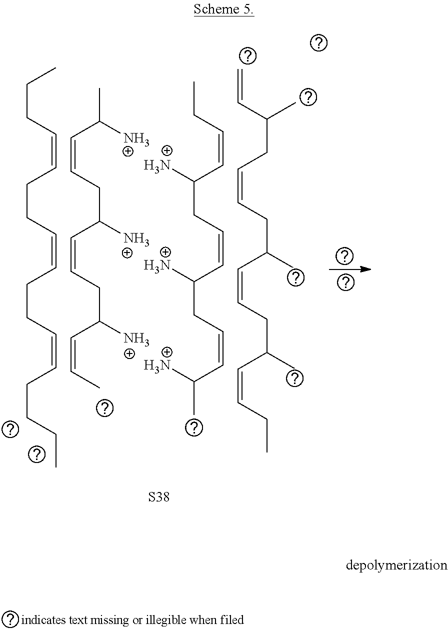

### F. EXAMPLES

The following preparations and examples are given to enable those skilled in the art to more clearly understand and to practice the present invention. They should not be considered as limiting the scope of the invention, but merely as being illustrative and representative.

In one aspect, disclosed are methods of making the product polymers as disclosed herein. In another aspect are disclosed methods of depolymerizing such product polymers to obtain non-polymeric nitrogen-containing small molecules.

Nuclear magnetic resonance (NMR) spectroscopy: ¹H and ¹³C NMR spectra were recorded on Bruker NMR spectrometers operating at 400, 500, and 600 MHz for ¹H (100, 125, and 150 MHz for ¹³C, respectively). These instrument models are listed here with the corresponding supporting federal grants: Bruker AVANCE III Nanobay 400 MHz, Bruker AVANCE III 500 MHz, Bruker AVANCE III 600 MHz, and Bruker AVANCE NEO 600 MHz. Chemical shifts are expressed in parts per million (ppm), and splitting patterns are designated as s (singlet), d (doublet), t (triplet), q (quartet), sept (septet), oct (octet), m (multiplet), b (broad), and combinations thereof. Scalar coupling constants J are reported in Hertz (Hz). MestReNova v14.1.0-24037 software (Mestrelab Research S.L.) was used to analyze the NMR spectra. ¹H and ¹³C NMR spectra were referenced to residual monoproteo-solvent peaks as reported in literature.⁵⁷

### Example 1: Small Molecule (MC4) 2-Aza-Cope Rearrangement

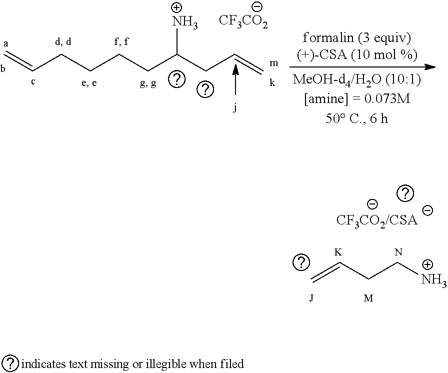

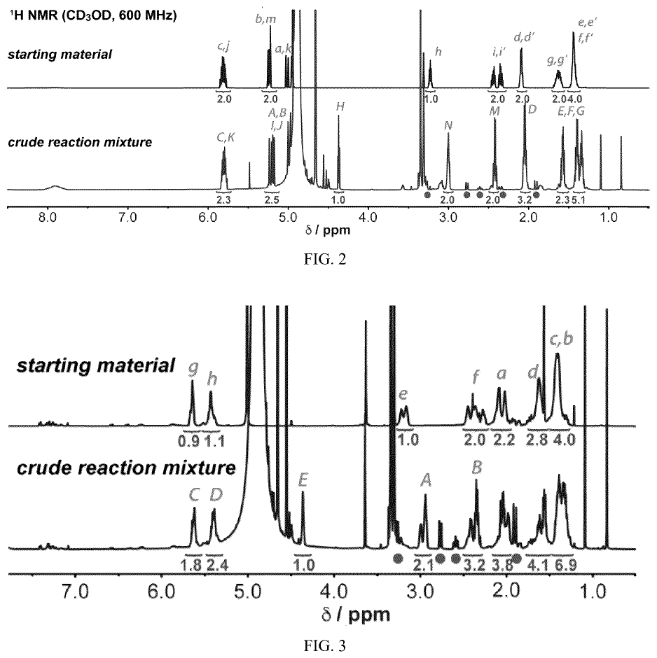

MC4 was prepared as the trifluoroacetate (TFA) salt and subjected to 2-aza-Cope rearrangement reaction conditions using 3 equiv of formaldehyde (in the form of formalin) and 0.1 equiv of CSA (amines were protonated to begin with) in CD3OD/H2O (10:1) at 50° C. After 6 h, based on 1H NMR spectroscopy of the crude reaction mixture—specifically, comparison of integration of the internal alkene resonances relative to the methine—MC4 underwent ˜90% conversion to the TFA/CSA salt of but-3-en-1-amine (i.e., homoallylamine) and the acetal/hemiacetal of hept-6-enal (FIG. 2). A possible reaction mechanism would be:

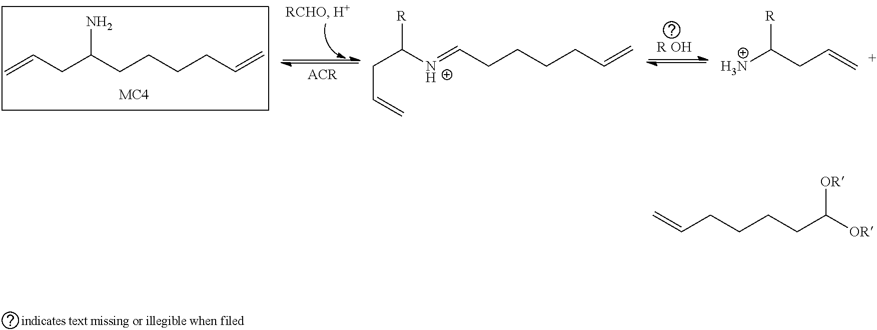

Resonance assignments were confirmed by 13C and 2D-NMR spectroscopy and spectral comparison with commercial homoallylamine mixed with (+)-CSA, as well as reported 1H NMR spectra of analogous acetals. 126 These results demonstrate that ACR of polymeric substrates leads to depolymerization.

### Example 2: Oligomer Model 2-Aza-Cope Rearrangement

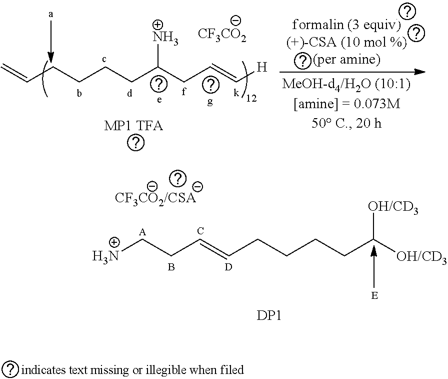

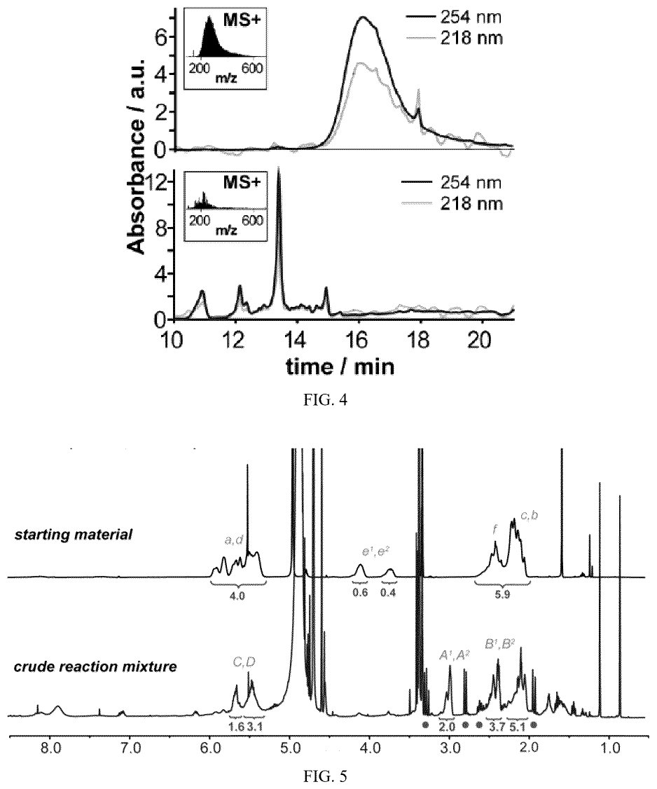

MP1 was prepared as the trifluoroacetate (TFA) salts and characterized by GPC-MALS to have Mn≈2800 g/mol-degree of polymerization (DP)≈12—and dispersity (Ð)=2.2. MP1 was subjected to 2-aza-Cope rearrangement reaction conditions using 3 equiv of formaldehyde (in the form of formalin) and 0.1 equiv of CSA (amines were protonated to begin with) in CD3OD/H2O (10:1) at 50° C. After 6 h, based on 1H NMR spectroscopy of the crude reaction mixture—specifically, comparison of integration of the internal alkene resonances relative to the methine—in 20 h, complete conversion of MP1 was observed by 1H NMR and LCMS, and based on 1H NMR analysis, and based on 1H NMR analysis, ˜50% conversion can be accounted for by the formation of DP1 or oligomers with the same end-groups. Assignments were confirmed by 13C and 2D-NMR spectroscopy and spectral comparison with commercial homoallylamine mixed with (+)-CSA, as well as reported 1H NMR spectra of analogous acetals.¹²⁶ These results demonstrated ACR of polymeric substrates which led to depolymerization (FIG. 3). In addition, mass spectra data was gathered and averaged over time (FIG. 4).

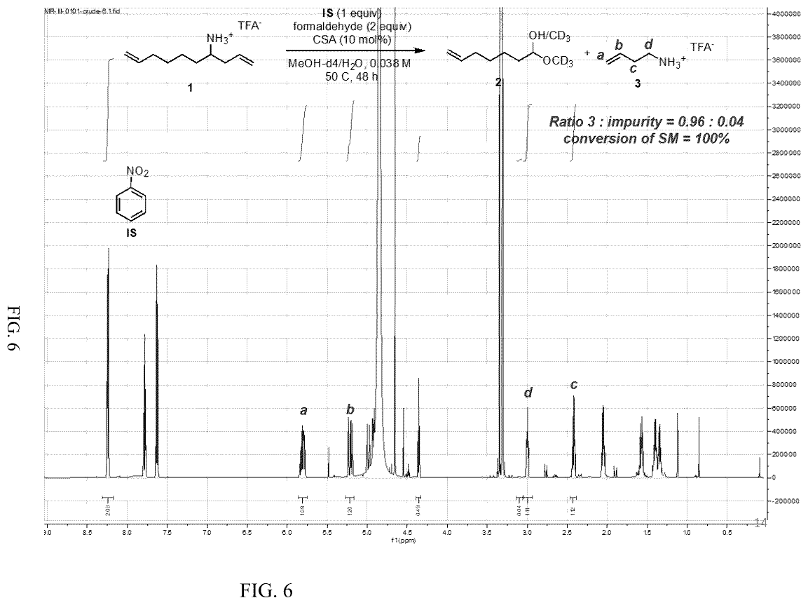

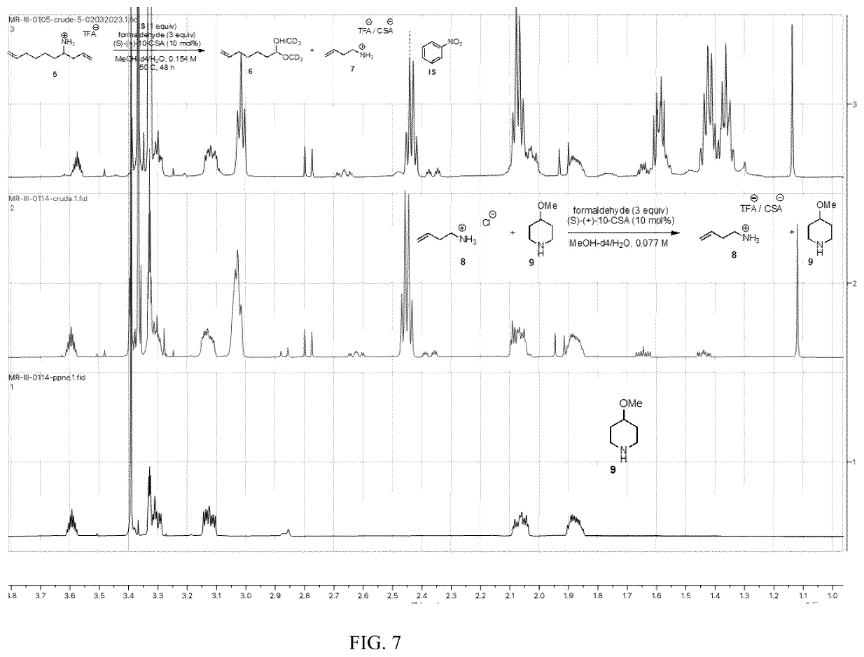

In addition optimization studies were carried out to optimize the ACR conditions in order to avoid the formation of impurities that could be formed. As such, FIG. 6-7 shows IN NMR data of such optimization studies using 4-nitrobenzene as an internal standard (IS)(1H NMR). A 1H NMR time study was able to identify the impurity as compound 9 shown in FIG. 7.

### Example 3: Polymer Model 2-Aza-Cope Rearrangement

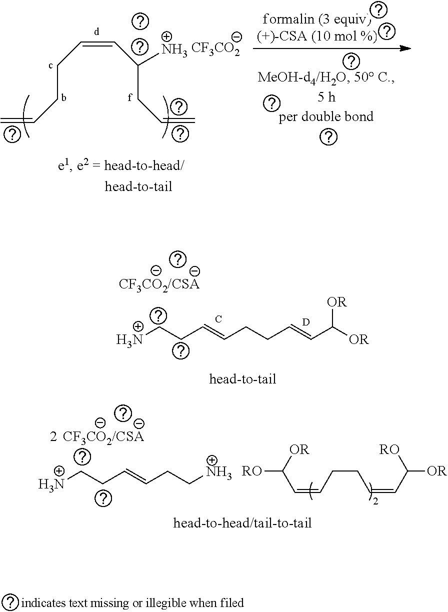

Polymer was prepared as the trifluoroacetate (TFA) salts according to known methods in the art and was subjected to 2-aza-Cope rearrangement reaction conditions using 3 equiv of formaldehyde (in the form of formalin) and 0.1 equiv of CSA (amines were protonated to begin with) in CD3OD/H2O (10:1) at 50° C. Reaction progress was assessed by 1H NMR spectroscopy of the crude reaction mixture. Assignments of each signal were confirmed by 13C and 2D-NMR spectroscopy and a spectral comparison was done with starting polymer mixed with (+)-CSA. These results demonstrated ACR of polymeric substrates which led to depolymerization (FIG. 3). In addition, mass spectra data was gathered and averaged over time (FIG. 5).

In addition an 1H NMR time study was carried out to monitor the consumption of starting material as well as the formation of products and reaction intermediates. As can be seen the starting material P1-TFA is consumed after 12 hours (see FIG. 7).

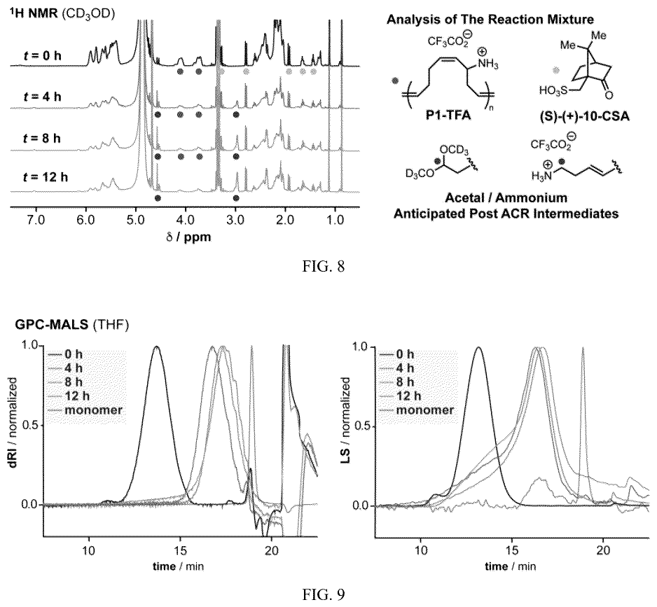

GPC-MALS time studies were carried out as well to complement the 1H NMR studies (FIG. 8).

### Example 4: Depolymerization of Rubber Species S38

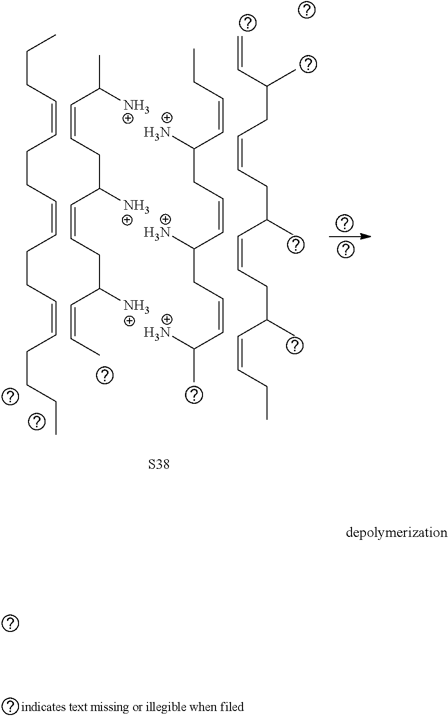

In a 100 mL Schlenk flask equipped with Teflon-coated stir bar was added S38 (200.5 mg, 1.095 mmol (assumed to be 100 wt % repeat unit for equivalents)) which was then suspended in CD₃OD (20 mL) and flushed with N₂ (g) before being capped with a septum. A 1-dram vial was charged with(S)-(+)-10-CSA (25.5 mg, 110 μmol, 0.10 eq*), formaldehyde (165 μL, 2.22 mmol, 2.02 eq* as 37% solution in water), H₂O (2.0 mL), and gently agitated until completely dissolved. The content of the 1-dram vial was then transferred into the Schlenk flask and the vial was then rinsed with CD₃OD (7.5 mL) to make the total volume of CD₃OD/H₂O 29.5 mL. The flask was then stirred at 50° C. for 48 hours under a slow stream of N₂(g). Aliquots for NMR and GPC analysis were then drawn at time periods starting after no solid particles remained t=3 h, 6 h, 12 h, 24 h, and 48 h (see Table 1).** *Numbers above reflect number of equivalents with respect to repeat unit assuming mass of S38 is 100 wt % a minimum repeat unit.** Analysis of the reaction mixture by ¹H NMR and GPC was performed as follows: an aliquot, corresponding to 2.0 mg of material was drawn from the reaction mixture, diluted with CD₃OD to bring total volume of the aliquot to 800 μL, and analyzed by 1H NMR (128 scans). Next, the content of the NMR tube was transferred into 5 mL vial equipped with stirring bar, and treated with Boc₂O (6.9 mg, 31.6 μmol, 5 equiv/[NH₃⁺ group]) as solution in Et₃N (200 μL). The content of the vial was stirred at room temperature for 1 h followed by solvent removal under reduced pressure. Crude material was dried under vacuum and then analyzed by GPC.

TABLE 1

| Sample | Mᵥ(g/mol)* | Mₙ (g/mol)* | M_{w} (g/mol)* | Mₙ (g/mol)* | Mw (g/mol)** |
|---|---|---|---|---|---|
| S38 at 3 hours | 39,500 ± 2.9% | 12,100 ± 41.7% | 84,300 ± 27.7% | 49,700 ± 2.3% | 70,900 ± 1.6% |
| S38 at 6 hours | 45,300 ± 1.5% | 20,900 ± 43.1% | 68,100 ± 30.5% | 40,600 ± 3.8% | 54,900 ± 3.2% |
| S38 at 12 hours | 14,500 ± 3.8% | 12,400 ± 30.1% | 22,100 ± 43.0% | 21,700 ± 3.3% | 35,300 ± 2.2% |
| S38 at 24 hours | 25,800 ± 1.5% | 15,900 ± 34.7% | 34,500 ± 31.3% | 27,700 ± 1.8% | 41,400 ± 1.7% |
| S38 at 38 hours | 13,900 ± 0.7% | 10,900 ± 9.6% | 20,500 ± 21.2% | 16,500 ± 4.4% | 30,000 ± 2.7% |

*Calculated from universal calibration curve constructed made from polystyrene standards.
**Calculated directly from light scattering trace.

It will be apparent to those skilled in the art that various modifications and variations can be made in the present invention without departing from the scope or spirit of the invention. Other aspects of the invention will be apparent to those skilled in the art from consideration of the specification and practice of the invention disclosed herein. It is intended that the specification and examples be considered as exemplary only, with a true scope and spirit of the invention being indicated by the following claims.

### REFERENCES

(1) Coates, G. W.; Getzler, Y. D. Y. L., Chemical Recycling to Monomer for an Ideal, Circular Polymer Economy. Nat. Rev. Mater. 2020, 5 (7), 501-516.
(2) Wolf, S.; Plenio, H., On the Ethenolysis of End-of-Life Tire Granulates. Green Chem. 2013, 15 (2), 315-319.
(3) Kasai, D., Poly(cis-1,4-Isoprene)-Cleavage Enzymes from Natural Rubber-Utilizing Bacteria. Biosci. Biotechnol. Biochem. 2020, 84 (6), 1089-1097.
(4) Soares, F. A.; Steinbüchel, A., Enzymatic and Chemical Approaches for Post-Polymerization Modifications of Diene Rubbers: Current State and Perspectives. Macromol. Biosci. 2021, 21 (12), 2100261
(5) Ricci, G.; Pampaloni, G.; Sommazzi, A.; Masi, F., Dienes Polymerization: Where We Are and What Lies Ahead. Macromolecules 2021, 54 (13), 5879-5914.
(6) Letcher, T. M.; Shulman, V.; Amirkhanian, S., Tire Waste and Recycling. Academic Press: 2021
(7) Saiwari, S.; Dierkes, W. K.; Noordermeer, J. W. M., Chapter 8. Recycling of Individual Waste Rubbers. In Rubber Recycling: Challenges and Developments, The Royal Society of Chemistry: 2019; pp. 186-232.
(8) Manoharan, P.; Naskar, K., Chapter 5. Recycling of Tire Rubbers and Their Re-Usability. In Rubber Recycling: Challenges and Developments, The Royal Society of Chemistry: 2019; pp. 102-127.
(9) Schulz, M. D.; Wagener, K. B., ADMET Polymerization. In Handbook of Metathesis, Wiley VCH: 2015; pp 313-355.
(10) Nor, H. M.; Ebdon, J. R., Ozonolysis of Natural Rubber in Chloroform Solution Part 1. A Study by GPC and FTIR Spectroscopy. Polymer 2000, 41 (7), 2359-2365
(11) Seidel, J.; Schmitt, G.; Hoffmann, M.; Jendrossek, D.; Einsle, O., Structure of the Processive Rubber Oxygenase Roxa from Xanthomonas Sp. Proc. Natl. Acad. Sci. USA 2013, 110 (34), 13833-13838
(12) Berto, P.; Grelier, S.; Peruch, F., Controlled Degradation of Polyisoprene and Polybutadiene: A comparative Study of Two Methods. Polym. Degrad. Stab. 2018, 154, 295-303.
(13) Espino, D.; Haruvy-Manor, Y.; Mastai, Y., CoFe₂O₄ Nano-Particles for Radical Oxidative Degradation of High Molecular Weight Polybutadiene. J. Polym. Environ. 2019, 27 (4), 827-836.
(14) Minoura, Y.; Shiina, K.; Harada, H., Lithiation of Diene Polymers. J. Polym. Sci. A Polym. Chem. 1968, 6 (3), 559-573.
(15) Minoura, Y.; Ikeda, H., Hydroboration of Diene Polymers. J. Appl. Polym. Sci. 1971, 15 (9), 2219-2236.
(16) Yamaguchi, H.; Azuma, K.; Minoura, Y., Asymmetric Hydroboration of Diene Polymers. Polym. J. 1972, 3 (1), 12-20.
(17) Fang, S.; Wu, S.; Huang, J.; Wang, D.; Tang, Z.; Guo, B.; Zhang, L., Notably Improved Dispersion of Carbon Black for High-Performance Natural Rubber Composites Via Triazolinedione Click Chemistry. Ind. Eng. Chem. Res. 2020, 59 (48), 21047-21057.
(18) Deepak, V. D.; Gungör, E.; Gauthier, M., Facile Synthesis of Poly(Isobutylene-Co-Isoprene) (IIR) Carboxylated Derivatives by Thiol-Ene Click Chemistry. Polym. J. 2021, 53 (2), 323-330.
(19) Nogueira, C. W.; Rocha, J. B. T., Toxicology and Pharmacology of Selenium: Emphasis on Synthetic Organoselenium Compounds. Arch. Toxicol. 2011, 85 (11), 1313-1359., I., Pericyclic Reactions, Oxford University Press, Inc.: New York, 1998.
(20) Walba, D. M.; Wand, M. D.; Wilkes, M. C., Convenient Stereoselective Syntheses of the Three Isomeric 2,6-Octadienes. J. Org. Chem. 1980, 45 (11), 2259-2261.
(21) Fleming, I, Pericyclic Reactions, Oxford University Press, Inc.: New York, 1998
(22) Dinda, B., Sigmatropic Rearrangements, Essentials of Pericyclic and Photochemical Reactions, Dinda, B., Ed. Springer International Publishing: Cham, Switzerland, 2017; Vol. 93, pp 107-160.
(23) Claisen, L., Über Umlagerung Von Phenol-allyläthern in C-allyl-phenole, Ber. Dtsch. Chem. Ges. 1912, 45 (3), 3157-3166.
(24) Tantillo, D. J.; Hoffmann, R., Helicoid Shiftamers, J. Am. Chem. Soc. 2002, 124 (24), 6836-6837.
(25) Tantillo, D. J.; Hoffmann, R., Sigmatropic Shiftamers: Fluxionality in Broken Ladderane Polymers, Angew. Chem. Int. Ed. 2002, 41 (6), 1033-1036.
(26) Tantillo, D. J.; Hoffmann, R., Helicoid Shiftamers for the Transport of π-Clumps and Charges, Helv. Chim. Acta 2003, 86 (11), 3525-3532.
(27) Tantillo, D. J.; Hoffmann, R., Hydrogen Migration over Organic Tapes: [1,5] Sigmatropic Shiftamers, Eur. J. Org. Chem. 2004, 2004 (2), 273-280.
(28) Tantillo, D. J.; Hoffmann, R.; Houk, K. N.; Warner, P. M.; Brown, E. C.; Henze, D. K., Extended Barbaralanes: Sigmatropic Shiftamers or σ-Polyacenes?, J. Am. Chem. Soc. 2004, 126 (13), 4256-4263.
(29) Tantillo, D. J.; Hoffmann, R., Snakes and Ladders. The Sigmatropic Shiftamer Concept, Acc. Chem. Res. 2006, 39 (7), 477-486.
(30) Sydlik, S. A.; Swager, T. M., Functional Graphenic Materials Via a Johnson-Claisen Rearrangement, Adv. Funct. Mater. 2013, 23 (15), 1873-1882.
(31) Tena, A.; Rangou, S.; Shishatskiy, S.; Filiz, V.; Abetz, V., Claisen Thermally Rearranged (CTR) Polymers, Sci. Adv. 2016, 2 (7), e1501859.
(32) Wang, W.; Qi, X.; Guan, Y.; Zhang, F.; Zhang, J.; Yan, C.; Zhu, Y.; Wan, X., Synthesis and Properties of Poly(p-phenylene terephthalamide) Bearing Both Polar and Unsaturated Substituents Introduced Via Claisen Rearrangement Reaction, J. Polym. Sci., Part A: Polym. Chem. 2016, 54 (13), 2050-2059.
(33) De la Viuda, M. R.; Tena, A.; Neumann, S.; Willruth, S.; Filiz, V.; Abetz, V., Novel Functionalized Polyamides Prone to Undergo Thermal Claisen Rearrangement in the Solid State, Polym. Chem. 2018, 9 (29), 4007-4016.
(34) Meis, D.; Tena, A.; Neumann, S.; Georgopanos, P.; Emmler, T.; Shishatskiy, S.; Rangou, S.; Filiz, V.; Abetz, V., Thermal Rearrangement of ortho-Allyloxypolyimide Membranes and the Effect of the Degree of Functionalization, Polym. Chem. 2018, 9 (29), 3987-3999.
(35) Fowler, F. W., Synthesis of 1,2- and 1,4-Dihydropyridines. J. Org. Chem. 1972, 37 (9), 1321-1323.

What is claimed is:

1. A method for preparing a product polymer having a nitrogen-containing backbone, the method comprising:
(a) obtaining a starting polymer, wherein the backbone of the starting polymer comprises at least one sigmatropomer repeat unit; and
(b) inducing a 2-azo-Cope rearrangement of the sigmatropomer in the backbone of the starting polymer, thereby producing the product polymer.

2. The method of claim 1, wherein the starting polymer is a compound of Formula IIa, IIb, or IIc: 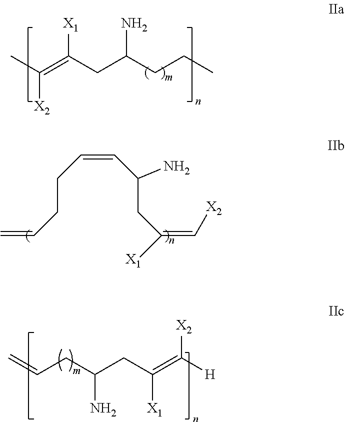
wherein X₁ and X₂ are independently selected from hydrogen, alkyl, aryl, and heteroaryl; m is an integer selected from 0-100; and n is an integer selected from 10-10,000.

3. The method of claim 2, wherein the starting polymer is a compound of Formula IIa or IIc, wherein m is an integer selected from 1-5.

4. The method of claim 2, wherein the starting material is a compound of Formula IIb, wherein n is an integer selected from 75-85.

5. The method of claim 2, wherein the starting material is a compound of Formula IIc, wherein n is an integer selected from 10-15.

6. The method of claim 1, wherein the sigmatropomer is a repeat unit of Formula I: 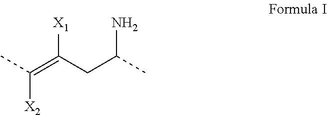
wherein X₁ and X₂ are independently selected from hydrogen, alkyl, aryl and heteroaryl.

7. The method of claim 1, wherein the 2-azo-Cope rearrangement is carried out at a temperature ranging from about 30° C. to about 150° C.

8. The method of claim 1, wherein the 2-azo-Cope rearrangement is carried out in the presence of an aldehyde R₂—C(═O) H, wherein R₂ is selected from cycloalkyl, alkyl, aryl, and heteroaryl.

9. The method of claim 8, wherein the aldehyde is selected from formaldehyde (formalin), benzaldehyde, 4-pyridinecarboxaldehyde, cyclohexanecarboxaldehyde, 4-nitrobenzaldehyde, and biphenyl-4-carboxaldehyde.

10. The method of claim 1, wherein the 2-azo-Cope rearrangement is carried out in the presence of a Brønsted acid.

11. The method of claim 10, wherein the Brønsted acid is selected from (+)-camphorsulfonic acid (CSA), diphenylphosphate (DPP), and p-toluenesulfonic acid (PTSA).

12. The method of claim 1, wherein X₁ and X₂ re hydrogen.

13. The method of claim 12, wherein the product polymer is selected from a compound of Formula PPa or PPc: 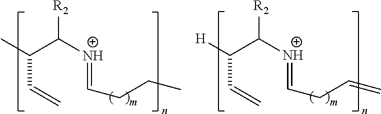
wherein R₂ is selected from cycloalkyl, alkyl, aryl, and heteroaryl; m is an integer selected from 0-100; and n is an integer selected from 10-10,000.

14. The method of claim 1 further comprising a depolymerizing step to produce one or more non-polymeric nitrogen-containing small molecules.

15. The method of claim 14, wherein the polymerizing step comprises contacting the product polymer with a polymerizing agent selected from water, an alcohol solvent, and a combination thereof.

16. The method of claim 15, wherein the polymerizing agent is a combination of water and methanol.

17. The method of claim 14, wherein one of the non-polymeric nitrogen-containing small molecules comprises a nitrogen-containing moiety of Formula III 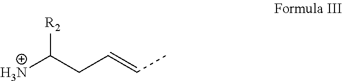
wherein R₂ is selected from cycloalkyl, alkyl, aryl, and heteroaryl.
